(19) United States
(12) Patent Application Publication
(10) Pub. No.: US 2026/0093764 A1
(43) Pub. Date: Apr. 2, 2026

(54) SOURCING OUTPUT OF GENERATIVE AI

(71) Applicant: Bank of America Corporation, Charlotte, NC (US)

(72) Inventors: Saurabh Mavani, Lake Hopatcong, NJ (US); Manoj Singireddy, Austin, TX (US); Manu Kurian, Dallas, TX (US)

(21) Appl. No.: 18/903,272

(22) Filed: Oct. 1, 2024

(51) Int. Cl. G06F 16/955; G06F 3/04812

(52) U.S. Cl. CPC G06F 16/9558; G06F 3/04812

(57) ABSTRACT

Apparatus and methods for sourcing responses of a large language model artificial intelligence/machine learning (generative AI) program are provided. The apparatus and methods may include a server with a response sourcing program. The response sourcing program may receive a response generated by the generative AI. The program may analyze the response and determine, to a pre-determined level, one or more sources for the response. The program may transmit the one or more sources to a user and display the sources to the user. The program may also query the generative AI to determine one or more sources.

### FIELD OF TECHNOLOGY

Aspects of the disclosure relate to providing apparatus and methods for providing the source(s) of output provided by a generative artificial intelligence to one or more users.

### BACKGROUND OF THE DISCLOSURE

Generative artificial intelligences (“AI” or “GenAI”) are becoming more widely used. Typically, generative AIs are based on one or more versions of a large language model (“LLM”). The source data used by the generative AI to produce an output may be unknown or unclear to a user.

Most LLMs are known as black box, meaning that it is unknown how the LLM produced an output from an input. This may be because the data or responses provided by the LLM is typically unsourced.

Additionally, it may be difficult to stand behind the product of a GenAI LLM specifically because there may always be some level of hallucinations within a generative AI. Without knowing the source of output, it may be difficult to determine where the hallucination(s) originated.

Therefore, it would be desirable for apparatus and methods for providing a user with the source(s) relied upon by the generative AI to produce a response.

### SUMMARY OF THE DISCLOSURE

It is an object of this disclosure to provide apparatus and methods for sourcing responses of large language models and other generative AI programs.

An apparatus to source responses of a large language model is provided. The apparatus may include a central server and one or more user devices.

The central server may include a server communication link, a server processor, and a server non-transitory memory. The server non-transitory memory may be configured to store a server operating system and a response sourcing program. Each program may be executed on the server processor.

The user device may include a device communication link, a device processor, and a device non-transitory memory. The device non-transitory memory may be configured to store at least a device operating system, and a user interface program executed on the device processor and adapted to interact with the large language model.

The response sourcing program may receive, over a network, a query from a user interacting with the user interface. The program may analyze the query. The program may determine, through one or more artificial intelligence/machine learning (“AI/ML”) algorithms trained on a store of data, one or more responses to the query.

The program may generate, based on the determined one or more responses, one or more outputs to the query. Each of the one or more outputs may include the determined one or more responses and one or more sources for each of the determined one or more responses.

The program may transmit, over the network, the one or more outputs to the user interface program. The program may display the one or more outputs on the user interface program.

In an embodiment, the network may be the Internet.

In an embodiment, the network may be an internal intranet.

In an embodiment, the one or more outputs may include one or more hyperlinks.

In an embodiment, each hyperlink may point or link to one of the one or more sources.

In an embodiment, the one or more outputs may include one or more popups. Each of the one or more popups may include one of the one or more sources.

An apparatus to source responses of a large language model is provided. The apparatus may include The apparatus may include a central server and one or more user devices.

The central server may include a server communication link, a server processor, and a server non-transitory memory. The server non-transitory memory may be configured to store a server operating system and a response sourcing program. Each program may be executed on the server processor.

The user device may include a device communication link, a device processor, and a device non-transitory memory. The device non-transitory memory may be configured to store at least a device operating system, and a user interface program executed on the device processor and adapted to interact with the large language model and the response sourcing program.

The response sourcing program may receive, over a network, a response from the large language model to a query from the user.

The program may analyze the response. The program may determine, through one or more artificial intelligence/machine learning (“AI/ML”) algorithms and to a pre-determined level of accuracy, one or more sources the large language model used to generate the response.

The program may transmit, over the network, the determined one or more sources to the user device.

The user device may display the determined one or more sources on the user interface program.

In an embodiment, the predetermined level of accuracy may be more likely than not.

In an embodiment, the predetermined level of accuracy may be variable.

In an embodiment, the response sourcing program may also query the large language model for the one or more sources.

In an embodiment, when the large language model provides the one or more sources, the response sourcing program may update the determined one or more sources.

In an embodiment, when the large language model provides the one or more sources, the response sourcing program may refine the one or more artificial intelligence/machine learning (“AI/ML”) algorithms.

In an embodiment, the determined one or more sources may be displayed as an overlay of the response.

In an embodiment, the determined one or more sources may be displayed as one or more hyperlinks.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative apparatus in accordance with principles of the disclosure.

### DETAILED DESCRIPTION OF THE DISCLOSURE

It is an object of this disclosure to provide apparatus and methods for providing sources used by a generative AI program in forming its responses.

An apparatus to source responses of a large language model is provided. The apparatus may include a central server and one or more user devices. In other embodiments, the server may be decentralized.

A generative AI may be an artificial intelligence/machine learning (“AI/ML”) algorithm configured to produce (i.e., generate) an output. The output may be textual, visual, audio, audiovisual, machine code, or in other formats.

Many generative AI algorithms are based on “large language models”. A large language model may be an algorithm (i.e., model) that is trained on a large body or source of data. The large body of data may be some or all of the internet, proprietary data, manufactured data, confidential data, audiovisual works, art, books, certain websites, source code, and other data. Some large language models may be trained on multiple sources or stores of data.

The central server may include a server communication link, a server processor, and a server non-transitory memory. The server non-transitory memory may be configured to store a server operating system and a response sourcing program. Each program may be executed on the server processor.

In an embodiment, the response sourcing program may include one or more generative AI algorithms or large language models.

The user device may include a device communication link, a device processor, and a device non-transitory memory. The device non-transitory memory may be configured to store at least a device operating system, and a user interface program executed on the device processor and adapted to interact with the large language model. The user interface program may be a program or application that is configured to query a generative AI program/large language model and receive responses to a query. In an embodiment, the user interface program may be a web-based application. In an embodiment, the user interface program may be a browser wherein the generative AI program/large language model may be accessed through a website.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The non-transitory memory may be configured to store executable data configured to run on the processor.

The microprocessor(s) may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, bluetooth, LAN, and cellular links. Multiple communication links may be present. In an embodiment, the network used to communicate may be the Internet. In another embodiment, the network may be an internal intranet or other internal network.

The response sourcing program may receive, over a network, a query from a user interacting with the user interface program. The user interface program may include a graphical user interface component to display data to the user. The query may be received over a communication link. In an embodiment, the query may be received from memory on the apparatus.

A query may be a request for a generative AI/the large language model to generate a response to the query. A response may be in any format, including audio, visual, audiovisual, textual, and code-based, or a combination of the above, depending on the query. Additional formats may be possible as well.

The response sourcing program/large language model may analyze the query. Analyzing the query may include determining what the user is requesting (a textual answer, a video, a sound, code, combination of formats, etc.), the contents of the request, and an efficient way of formulating a response. Any generative AI algorithm or combination of algorithms may be used.

The response sourcing program/large language model may determine, through one or more artificial intelligence/machine learning (“AI/ML”) algorithms trained on a store of data, one or more responses to the query. Any suitable generative AI/ML algorithm may be used. The training may be an ongoing process or it may have been previously accomplished. A response to the query may include a generated answer or other result.

The store of data may include public and private data. Public data may include data available on the internet. Private data may include personal information unique to the user (such as, e.g., bank account information), or data that is proprietary to an entity (such as source code, contracts, etc.).

The response sourcing program may generate, based on the determined one or more responses, one or more outputs to the query. Each of the one or more outputs may include, inter alia, the determined one or more responses and one or more sources for each of the determined one or more responses. Outputs, as used in this disclosure, include both the responses to a query as well as the sources of data the generative AI/ML algorithm(s) used to formulate the responses. The one or more sources may include metadata or other data linking to a location where the source may be located, instead of the actual source file (e.g., source document, webpage). Using data pointing to the location and identity of the source file may save computing resources such as memory and bandwidth.

In an embodiment, the one or more sources may include the actual source file instead of data pointing to where the source file may be located.

In an embodiment, there may be a separate source for each word of the determined response. In an embodiment, there may be one source for multiple words of the determined response.

The response sourcing program may transmit, over the network, the one or more outputs to the user interface program. In an embodiment, the network may be a different network than the network used to transmit the query. The program may display the one or more outputs through the user interface program. The type of display may vary based on the response(s), the queries, and the capabilities of the user device.

In an embodiment, the network may be the Internet. It is anticipated that the queries and responses will be most widely used on the Internet.

In an embodiment, the network may be an internal intranet. Using an internal intranet may allow for a different source of data (such as proprietary information like source code, or confidential information such as bank account data) to be used to generate a response and output.

In an embodiment, the output may be encrypted. Any suitable encryption method or algorithm may be used. Encrypting the output may allow for transmission of proprietary or confidential source information.

In an embodiment, the one or more outputs may include one or more hyperlinks. Each word or phrase of the response may be hyperlinked to the same or different source(s). For example, if the response is “A B and C,” each of A, B, and C may be hyperlinked to the same or different source. A hyperlink may be a computerized address (web or in a database) where a file or other data may be located.

In an embodiment, each hyperlink may point or link to one of the one or more sources. A source may be a file, a website, or other source of digital data.

In an embodiment, the one or more outputs may include one or more popups. Each of the one or more popups may include one of the one or more sources. When the user mouses over (or touches) a particular word, a popup may appear with the source, or a link to the source. A popup may be a bubble. For example, if the response is “A B and C,” each of A, B, and C may be linked to the same or a different popup so when the user mouses over or touches A one popup will appear, and the same for B and C.

An apparatus to source responses of a large language model is provided. The apparatus may include a central server and one or more user devices. In an embodiment, the server may be decentralized.

The central server may include a server communication link, a server processor, and a server non-transitory memory. The server non-transitory memory may be configured to store a server operating system and a response sourcing program. Each program may be executed on the server processor.

The user device may include a device communication link, a device processor, and a device non-transitory memory. The device non-transitory memory may be configured to store at least a device operating system, and a user interface program executed on the device processor and adapted to interact with the large language model and the response sourcing program.

The response sourcing program may receive, over a network, a response from the large language model to a query from the user. In this embodiment, the response sourcing program may not generate the response.

The program may analyze the response to determine what source(s) the large language model or other generative AI algorithm used to generate the response.

The program may determine, through one or more artificial intelligence/machine learning (“AI/ML”) algorithms and to a pre-determined level of accuracy, one or more sources the large language model used to generate the response.

In an embodiment, the program may determine the one or more sources through a separate query (requesting the sources to the response) to the large language model/generative AI algorithm.

The program may transmit, over the network, the determined one or more sources to the user device. In various embodiments, the program may transmit both the response and the determined one or more sources. For example, the program may transmit the sources, or a link to where the sources may be located, as embedded within the response. Embedded may be a hyperlink, a popup, a footnote, or other graphical and/or tactile display.

The user device may display the determined one or more sources on the user interface program. In an embodiment, the display may include both the response and determined one or more sources. For example, the determined one or more sources may be embedded within the response, as, for example, hyperlinks, popups, footnotes, audio files, or other display.

When the program does not know with 100% accuracy that a response or portion of a response is generated from a particular source, it may still present what the program determines to be the response. Different levels of determination are possible. For example, the program may determine that this source is 20% likely, this other source is 80% likely to be the actual source, and this third possible source is 75% likely to be the actual source. In various embodiments, the program may transmit one or both of the 75% or 80% likely sources.

In an embodiment, the predetermined level of accuracy may be more likely than not, i.e. 50%+1.

In an embodiment, the predetermined level of accuracy may be variable. The program may vary the level of accuracy automatically. For example, if the predetermined level is set at 90% but the program cannot find a source with that level of accuracy, it may automatically lower the level until it finds a source that meets the new, lower level. Conversely, if the level is set at 50+1% (more likely than not), and the program finds multiple possible sources at that level of accuracy, it may automatically increase the level until only one source remains, as the source it determines to be the most likely source.

In an embodiment, the predetermined level of accuracy may be set or varied by the user. For example, the user may request all possible sources no matter the level of accuracy. Or the user may request only the most likely source.

In an embodiment, the response sourcing program may also query the large language model for the one or more sources. This may work with some large language models, but not be available for others.

In an embodiment, when the large language model provides the one or more sources, the response sourcing program may update the determined one or more sources. In this embodiment, the program may determine on its own what it believes to be the one or more sources. It may update its determinations as well as its algorithm(s) with the feedback from the large language model.

In an embodiment, when the large language model provides the one or more sources, the response sourcing program may refine the one or more artificial intelligence/machine learning (“AI/ML”) algorithms. Feedback from the large language model may assist the program in becoming more accurate as it is trained on correct and incorrect determinations.

In an embodiment, the determined one or more sources may be displayed as an overlay of the response. In an embodiment, the determined one or more sources may be displayed as one or more hyperlinks. Other types of displays, such as footnotes, popups, sidenotes, and other formats may be used as well.

A method for sourcing responses of a large language model is provided. The method may include the step of receiving, at a response sourcing program executed on a server, a response from the large language model to a query from a user.

The method may include the step of analyzing the response.

The method may include the step of determining, to a predetermined level and through one or more artificial intelligence/machine learning (“AI/ML”) algorithms, one or more sources the large language model used to generate the response.

The method may include the step of transmitting, over a network, the determined one or more sources to a user device.

The method may include the step of displaying the determined one or more sources on a user interface program on the user device.

In an embodiment, the server may be centralized.

In an embodiment, the network may be the Internet.

In an embodiment, the method may include the step of determining a level of confidentiality of each of the one or more sources. For example, personal financial data may be highly confidential, while data available freely on the internet may have zero confidentiality.

In an embodiment, when the level of confidentiality exceeds a predetermined threshold, the method may include the step of hiding the source. For example, if the source of the response is an analysis of a group of personal financial data or documents, these data or documents may not be available to be shared with a user. When this occurs, the program may inform the user that the source is confidential.

In various embodiments, the server may be decentralized. A decentralized server may be more powerful than a centralized server but may be less secure and more expensive.

The response sourcing program may utilize one or more artificial intelligence/machine learning (“AI/ML”) algorithms to perform one or more of its functions. Any suitable AI/ML algorithm may be used.

The response sourcing program may include a user interface. The user interface may be a graphical user interface. The response sourcing program may include one or more modules. Each module may be configured to perform one or more functions.

The pre-determined thresholds may be more likely than not, i.e., this source is more likely than not the source used by the large language model to generate its response. In various embodiments, the pre-determined threshold may be higher than more likely than not. In various embodiments, the pre-determined threshold may be variable. It may be variable by the user. It may be automatically varied by the program based on various factors, including amount of time to determine a source (i.e., if it is taking too long, it may lower the threshold).

The response sourcing program may store the outputs on the non-transitory memory. Storing the outputs may allow for valid record-keeping, auditing of the data, training of the program, iteration of the program, and provide a check on the validity of the outputs transmitted to the user.

In an embodiment, the server may be centralized. In an embodiment, the server may be distributed, to utilize a larger pool of computing resources and provide redundancy. Centralized servers may be easier to secure but also provide a single failure point. Distributed servers may be more robust but may provide multiple avenues for malicious actors to target.

In an embodiment, the network may be the Internet. In another embodiment, the network may be an internal intranet. An internal intranet may be more limited than the Internet, but it may also be more secure. In an embodiment, the network may be encrypted.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

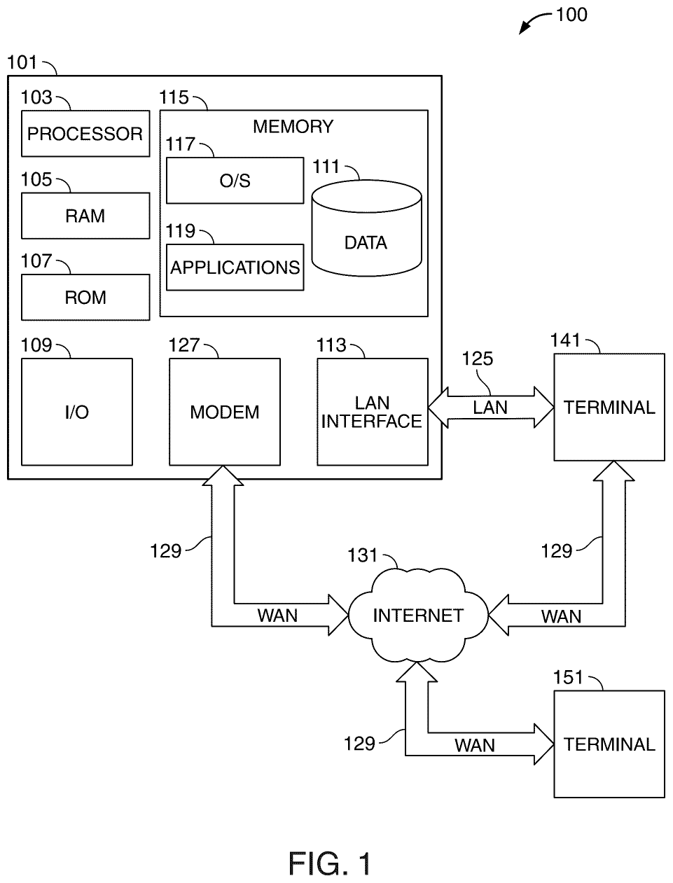

In accordance with principles of the disclosure, FIG. 1 shows an illustrative block diagram of apparatus 100 that includes a computer or computer system 101. Computer 101 may alternatively be referred to herein as a “computing device” or “computing system”. Computer 101 may be any suitable computing device or part of a computing device. Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more standard microprocessors 103 for controlling the operation of the device and its associated components, and may include RAM 105, ROM 107, input/output module 109, and a memory 115. The processors 103 may also execute all software running on the computer 101—e.g., the operating system 117 and applications 119 such as a response sourcing program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as the entity response sourcing program and an authentication engine) along with any other data 111 (e.g., traits and authentication information for users and entities) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

In an embodiment of the server 101, the processor 103 may execute the instructions in all or some of the operating system 117, any applications 119 in the memory 115, any other code necessary to perform the functions in this disclosure, and any other code embodied in hardware or firmware (not shown).

An input/output (“I/O”) module 109 may include connectivity to a keyboard, monitor, microphone, or network interface through which higher hierarchal server or a user of server 101 may provide input. The input may include input relating to cursor movement. The input/output module 109 may also include one or more speakers for providing audio output and a video display device, such as an LED screen and/or touchscreen, for providing textual, audio, audiovisual, and/or graphical output (not shown).

In an embodiment, apparatus 100 may consist of multiple servers 101, along with other devices.

Apparatus 100 may be connected to other systems, computers, servers, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-ﬁ).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Server 101 may include a network interface controller (not shown), which may include a modem 127 and LAN interface or adapter 113, as well as other components and adapters (not shown).

When used in a LAN networking environment, server 101 is connected to LAN 125 through a LAN interface or adapter 113. When used in a WAN networking environment, server 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-ﬁ, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The server may transmit data to any other suitable computer system. The server may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for invoking user functionality related to performing various tasks. In an embodiment, application program(s) 119 may be cloud-based applications. In an embodiment, application program(s) 119 may be programs such as a response sourcing program and/or security protocols. In an embodiment, the response sourcing program may use one or more AI/ML algorithm(s). The various tasks may be related to sourcing responses of large language models and other generative AI programs.

Server 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, smart mobile device, or any other suitable device for receiving, storing, transmitting and/or displaying relevant information. Terminal 151 and/or terminal 141 may be other devices such as remote servers. The terminals 151 and/or 141 may be computers where the user is interacting with the application that is being monitored by apparatus 100.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, server computers, hand-held or laptop devices, tablets, mobile phones, smart phones, smart mobile devices, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

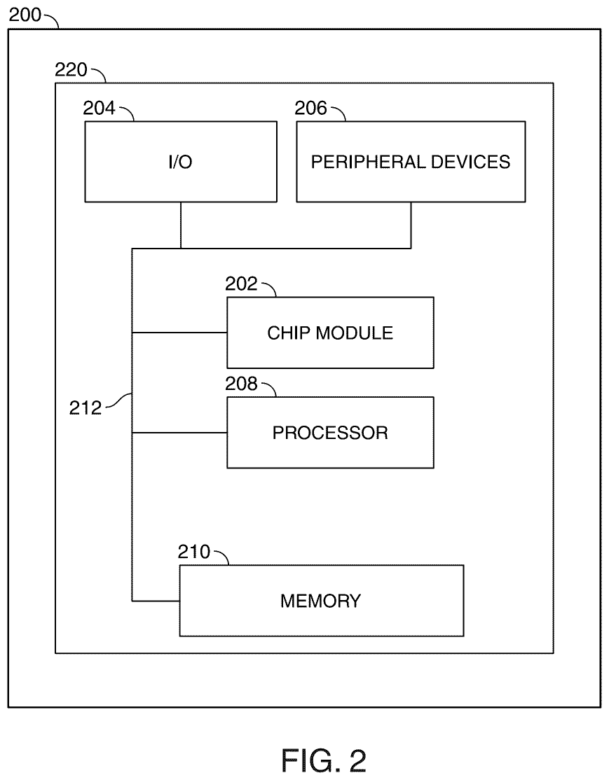

FIG. 2 shows illustrative apparatus 200 that may be configured in accordance with the principles of the disclosure. Apparatus 200 may be a server, user device, or other computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

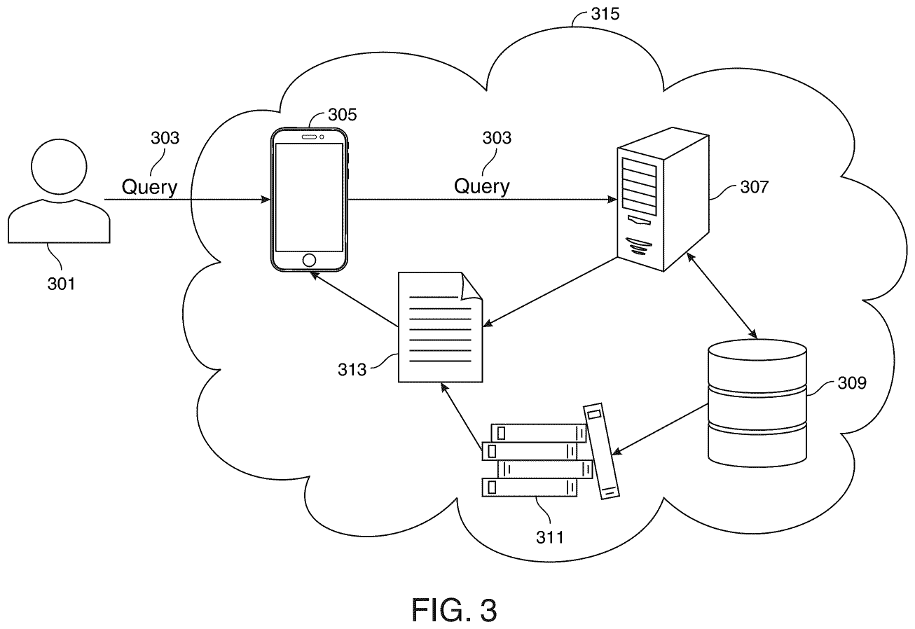

FIG. 3 shows an illustrative schematic in accordance with principles of the disclosure. A user 301 may input a query 303 on a user device 305.

The query 303 may be transmitted over network 315 to server 307.

Server 307 (i.e. a program on the server) may analyze the query 303 and formulate a response and output 313. Output 313 may include the response to the query 303 and sources 311 for the response. The server 307 may use a data store 309 to formulate its response. Sources 311 may be located in the data store 309.

The output 313 may be transmitted to the user device 305 and displayed on the user device 305.

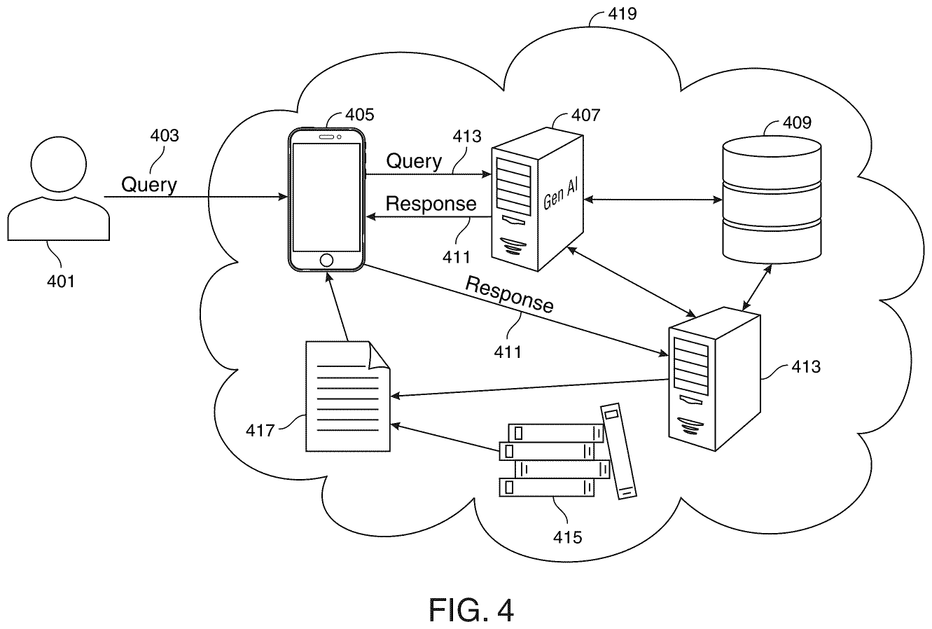

FIG. 4 shows an illustrative schematic in accordance with principles of the disclosure. A user 401 may input a query 403 on a user device 405.

The query 403 may be transmitted over network 419 to a generative AI server 407.

GenAI server 407 (i.e. a program on the server) may analyze the query 403 and formulate a response 411. The genAI server 407 may use a data store 409 to formulate its response.

The response 411 may be transmitted back to the user device 405 over the network 419.

The user device 405 may transmit the response 411 to a server 413 running a response sourcing program over network 419. The response sourcing program may analyze the response 411 to determine, to some predetermined threshold of accuracy, likely sources 415 of the response 411. Sources 415 may be located in the data store 409. The server 413 may communicate with the genAI server 407 over the network 419 or other network.

The response sourcing program on server 413 may generate an output 417. Output 417 may include the response 411 and the sources 415.

The response sourcing program may transmit the output 417 to display on the user device 405.

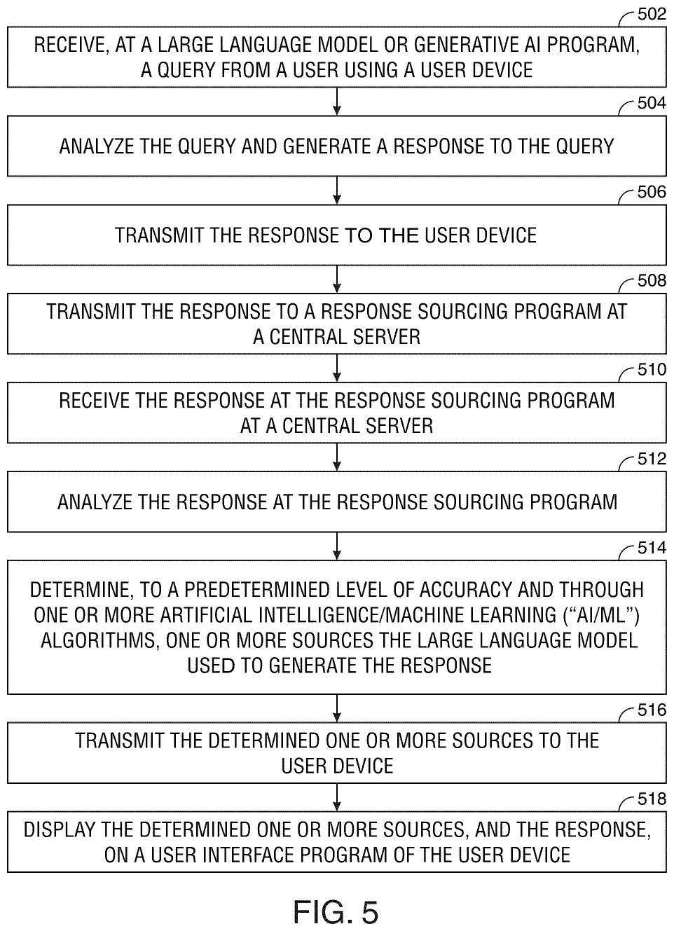

FIG. 5 shows an illustrative flowchart in accordance with principles of the disclosure. Methods may include some or all of the method steps numbered 502 through 518. Methods may include the steps illustrated in FIG. 5 in an order different from the illustrated order. The illustrative method shown in FIG. 5 may include one or more steps performed in other figures or described herein. Steps 502 through 518 may be performed on the apparatus shown in FIGS. 1-4, and 6, or other apparatus.

At step 502, a user may transmit a query using a user device to a large language model or generative AI program, and the query may be received by the program.

At step 504, the generative AI program may analyze the query and generate a response to the query.

At step 506, the generative AI program may transmit the response to the user device.

At step 508, the user may transmit the response to a response sourcing program at a server. The server may be centralized or decentralized.

At step 510, the response sourcing program may receive the response.

At step 512, the response sourcing program may analyze the response.

At step 514, the response sourcing program may determine, to a predetermined level of accuracy and through one or more artificial intelligence/machine learning (“AI/ML”) algorithms, one or more sources the large language model/generative AI program used to generate the response.

At step 516, the response sourcing program may transmit the determined one or more sources to the user device.

At step 518, a user interface program or other program may display the determined one or more sources and the response to the user on the user device.

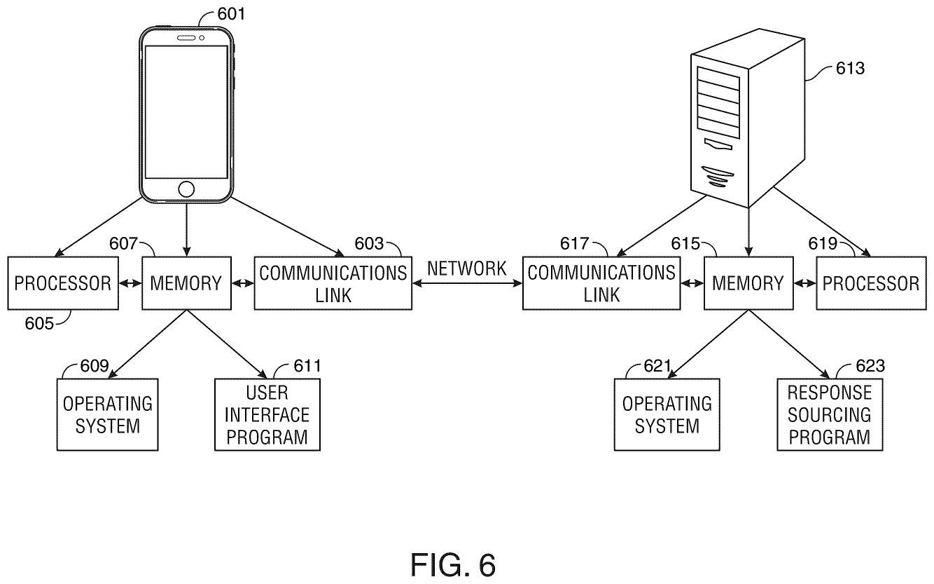

FIG. 6 shows an illustrative apparatus in accordance with principles of the disclosure. The apparatus may include a user device 601 and a computer system 613. Computer system 613 may be a centralized or decentralized server.

User device 601 may include a device communications link 603, a standard processor/processors 605, a device non-transitory memory 607, as well as other components, such as a graphical user interface.

Computer system 613 may include a server communications link 617, a standard processor/processors 619, a server non-transitory memory 615, as well as other components, such as a graphical user interface.

The device non-transitory memory 607, may include a device operating system 609, as well as a user interface program 611, as well as other data and programs.

The communications link 603 may communicate with other computer systems, such as computer system 613 and databases over a network.

The server non-transitory memory 615, may include a server operating system 621, as well as a response sourcing program 623, as well as other data and programs.

The response sourcing program 623 may receive, over the network, a response from a large language model to a query from the user device 601.

The program 623 may analyze the response.

The program 623 may determine, to a predetermined level of accuracy and through one or more artificial intelligence/machine learning (“AI/ML”) algorithms, one or more sources the large language model used to generate the response.

The program 623 may transmit, over the network, the determined one or more sources to the user device 601.

The user device 601 may display the determined one or more sources on the user interface program 611.

Thus, apparatus and methods for sourcing responses from a large language model/generative AI program are provided. Persons skilled in the art will appreciate that the present invention can be practiced by other than the described embodiments, which are presented for purposes of illustration rather than of limitation.

What is claimed is:

1. An apparatus to source responses of a large language model, the apparatus comprising:
a central server, the central server comprising:
a server communication link;
a server processor; and
a server non-transitory memory configured to store at least:
a server operating system; and
a response sourcing program executed on the server processor; and
a user device, the user device comprising:
a device communication link;
a device processor; and
a device non-transitory memory configured to store at least:
a device operating system; and
a user interface program executed on the device processor and adapted to interact with the large language model;
wherein the response sourcing program:
receives, over a network, a query from a user interacting with the user interface;
analyzes the query;
determines, through one or more artificial intelligence/machine learning (“AI/ML”) algorithms trained on a store of data, one or more responses to the query;
generates, based on the determined one or more responses, one or more outputs to the query, wherein the one or more outputs comprise:
the determined one or more responses; and
one or more sources for each of the determined one or more responses;
transmits the one or more outputs to the user interface program; and
displays the one or more outputs on the user interface program.

2. The apparatus of claim 1 wherein the network is the Internet.

3. The apparatus of claim 1 wherein the network is an internal intranet.

4. The apparatus of claim 1 wherein the one or more outputs comprises one or more hyperlinks.

5. The apparatus of claim 4 wherein each hyperlink points to one of the one or more sources.

6. The apparatus of claim 1 wherein the one or more outputs includes one or more popups.

7. The apparatus of claim 6 wherein each of the one or more popups comprises one of the one or more sources.

8. An apparatus to source responses of a large language model, the apparatus comprising:
a central server, the central server comprising:
a server communication link;
a server processor; and
a server non-transitory memory configured to store at least:
a server operating system; and
a response sourcing program executed on the server processor; and
a user device, the user device comprising:
a device communication link;
a device processor; and
a device non-transitory memory configured to store at least:
a device operating system; and
a user interface program executed on the device processor and adapted to interact with the large language model and the response sourcing program;
wherein the response sourcing program:
receives, over a network, a response from the large language model to a query from the user;
analyzes the response;
determines, to a predetermined level and through one or more artificial intelligence/machine learning (“AI/ML”) algorithms, one or more sources the large language model used to generate the response;
transmits, over the network, the determined one or more sources to the user device; and
displays the determined one or more sources on the user interface program.

9. The apparatus of claim 8 wherein the predetermined level is more likely than not.

10. The apparatus of claim 8 wherein the predetermined level is variable.

11. The apparatus of claim 10 wherein the response sourcing program further:
queries the large language model for the one or more sources.

12. The apparatus of claim 11 wherein when the large language model provides the one or more sources, the response sourcing program updates the determined one or more sources.

13. The apparatus of claim 11 wherein when the large language model provides the one or more sources, the response sourcing program refines the one or more artificial intelligence/machine learning (“AI/ML”) algorithms.

14. The apparatus of claim 8 wherein the determined one or more sources are displayed as an overlay of the response.

15. The apparatus of claim 8 wherein the determined one or more sources are displayed as one or more hyperlinks.

16. A method for sourcing responses of a large language model, the method comprising:
receiving, at a response sourcing program executed on a server, a response from the large language model to a query from a user;
analyzing the response;
determining, to a predetermined level and through one or more artificial intelligence/machine learning (“AI/ML”) algorithms, one or more sources the large language model used to generate the response;
transmitting, over a network, the determined one or more sources to a user device; and
displaying the determined one or more sources on a user interface program on the user device.

17. The method of claim 16 wherein the server is centralized.

18. The method of claim 16 wherein the network is the Internet.

19. The method of claim 16 further comprising the step of determining a level of confidentiality of each of the one or more sources.

20. The method of claim 19 wherein when the level of confidentiality exceeds a predetermined threshold, hiding the source.
